(19) United States
(12) Patent Application Publication
(10) Pub. No.: US 2006/0185073 A1
(43) Pub. Date: Aug. 24, 2006

(54) Mechanical footbath

(76) Inventor: Kam Fai Fung, Tuen Mun (CN)

Correspondence Address: STEVEN A. GARNER, ESQ.;CONAIR CORPORATION, ONE CUMMINGS POINT ROAD, STAMFORD, CT, 06902, US

(21) Appl. No.: 11/350,913

(22) Filed: Feb. 9, 2006

Related U.S. Application Data
(60) Provisional application No. 60/652,079, filed on Feb. 11, 2005.

(51) Int. Cl. A47K 3/022; A61H 35/00; E03C 1/00

(52) U.S. Cl. 4/622

(57) ABSTRACT

A mechanical footbath device that includes a body that has a base and a basin within which water can be contained. Within the basin is a bottom level formed therein. The body has a top level and side walls extending up from the bottom level. The footbath has a heater to heat the water placed within the footbath. Located on the bottom level of the footbath can be several massaging members to massage a body part, such as a foot. The massaging members can be made to be interchangeable with other members of different textures or patterns for a wide variety of massaging sensations and can be made to spin clockwise or counterclockwise. The footbath can include a control panel in the form of a body control panel having several buttons to control the various features of the footbath.

### CROSS-REFERENCE TO RELATED APPLICATIONS

This application claims priority to U.S. Provisional Patent Application Ser. No. 60/652,079 filed on Feb. 11, 2005, incorporated herein by reference in its entirety.

### BACKGROUND OF THE INVENTION

1. Field of the Invention

The present invention relates to footbath devices for therapy or comfort and, more particularly, to a mechanical footbath device with rotating massage members that are interchangeable with one another.

2. Description of Related Art

It is known in the art to provide various types of footbaths and foot spa therapy devices. Typical footbaths utilize water that is heated, so that a user's feet may be submerged into the heated water. At least one known device utilizes steam that can be released into a footbath basin that is similar in construction to a water-type footbath.

It is also known in the art to employ multiple mechanical switches as well as an array of switches on an infrared remote hand piece to control the settings on the various features available in an electric footbath. The features can include, for example, heat, vibration, air and water pumps, ozone and infrared lamps. The vibration features are usually located on the top level of the footbath above the water level. Each of the feature parameters can have a range of settings. The various settings can be powered independently or through a single common on/off switch.

There is a need, however, for a footbath where the vibration features are located on the bottom level of the footbath under the water and are interchangeable among several different vibration members having different textures or patterns for a wide variety of massaging sensations.

### OBJECT AND SUMMARY OF THE INVENTION

It is an object of the present invention to overcome the shortcomings of the prior art mentioned above. These and other objects are achieved by the present invention described herein.

The present invention is directed to a mechanical footbath device that includes a body that has a base and a basin within which water can be contained. Within the basin is a bottom level formed therein. The body has a top level and side walls extending up from the bottom level. The footbath has a heater to heat the water placed within the footbath. Located on the bottom level of the footbath can be several massaging members to massage a body part, such as a foot. The massaging members can be made to be interchangeable with other members of different textures or patterns for a wide variety of massaging sensations and can be made to spin clockwise or counterclockwise. The footbath can include a control panel in the form of a body control panel having several buttons to control the various features of the footbath.

### BRIEF DESCRIPTION OF THE DRAWINGS

The present invention is more fully understood by reference to the following detailed description of an illustrative embodiment with the drawing identified below.

FIG. 1 is a perspective view of a device according to a preferred embodiment of the present invention.

FIG. 2 is a top view of a device according to a preferred embodiment of the present invention.

FIG. 3 is a perspective view of a motor and gear system in accordance with an illustrative embodiment of the device shown in FIG. 1.

FIG. 4 is a side view of the device in accordance with a preferred embodiment of the present invention.

FIG. 5 is a top view of the device in accordance with a preferred embodiment of the present invention.

### DETAILED DESCRIPTION OF THE INVENTION

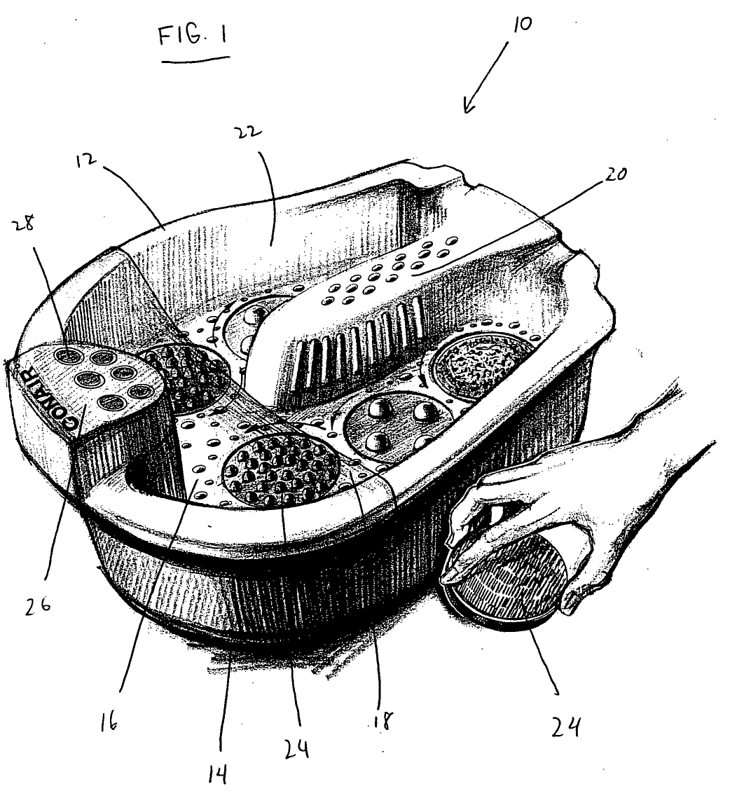

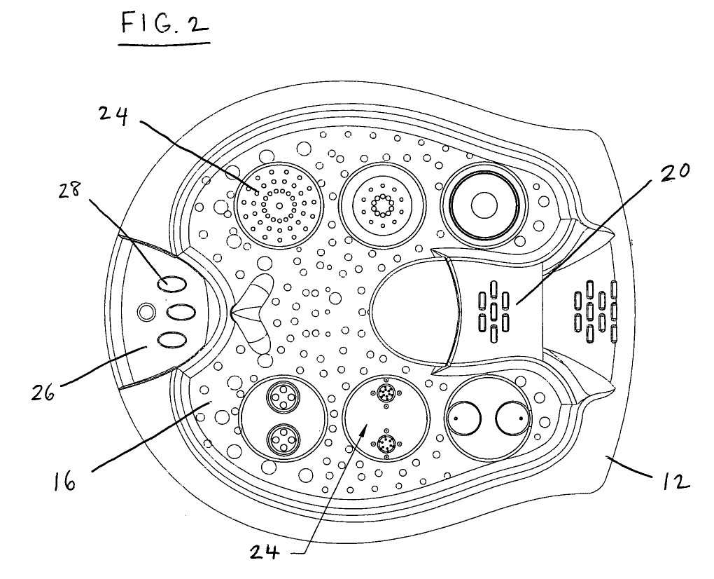

A preferred embodiment of the present invention mechanical footbath 10 is shown in FIGS. 1 and 2. The footbath 10 comprises a body 12 that has a base 14 and a basin 16 within which water can be contained. Within the basin 16 is a bottom level 18 formed therein. The body has a top level 20 and side walls 22 extending up from the bottom level 18. The footbath 10 has a heater (not shown) to heat the water (not shown) placed within the footbath 10.

Located on the bottom level 18 of the footbath 10 can be several massaging members 24 to massage a body part, such as a foot. In a preferred embodiment, each massaging member 24 is in the shape of a circle and is made to rotate about its central axis. Preferably, the massager heads 24 are completely immersed in the water.

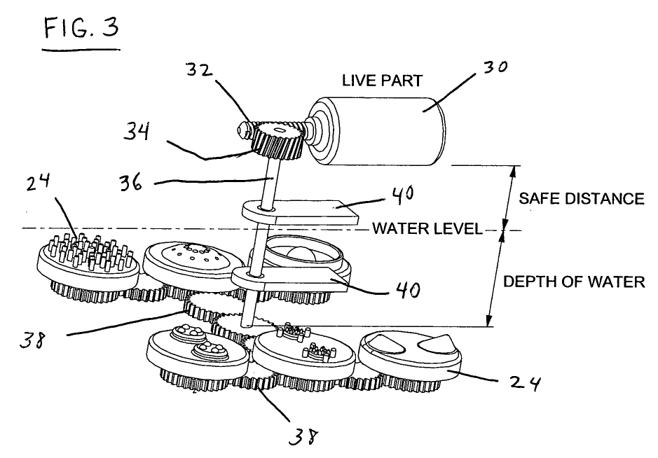

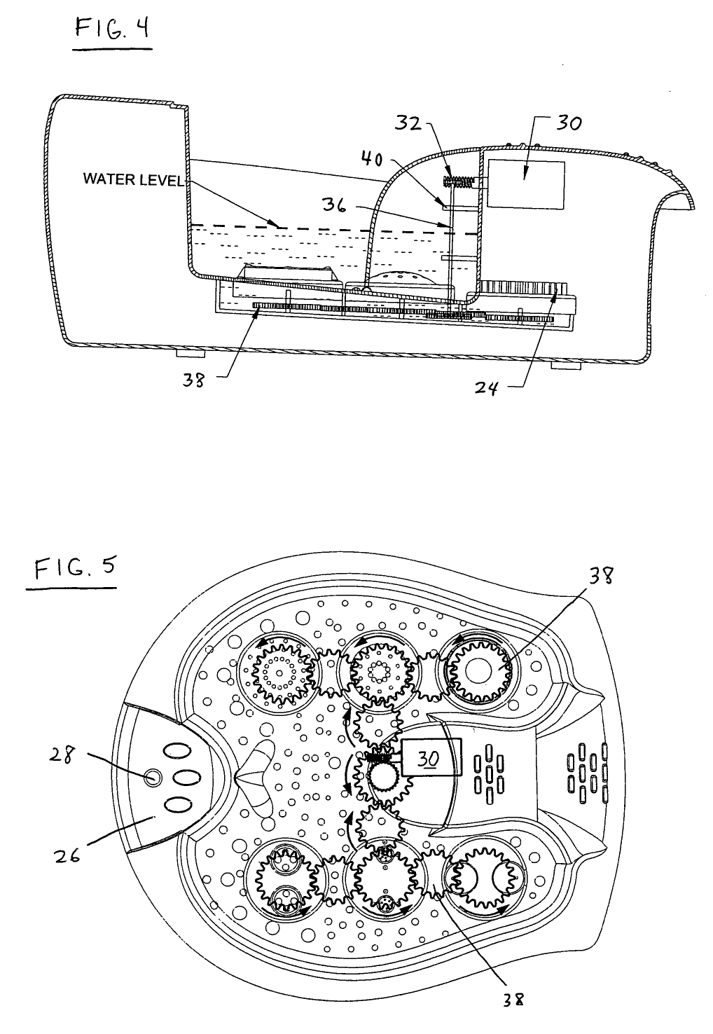

A motor and gear system can be used to rotate the massaging members 24. FIGS. 3-5 show a preferred embodiment of such a system. A motor 30, a live part, is preferably located at the upper part of the footbath a safe distance above the water level. The motor 30 can rotate a motor shaft gear 32, which can extend outward from the motor toward the center of the basin 16. As the motor shaft gear 32 rotates, it causes a pole gear 34 to rotate about an axis perpendicular to the motor shaft gear 32. The rotation of the motor pole gear 34 thereby causes the associated pole 36 to rotate as well. The pole 36 is preferably connected to a series of spur gears 38. These spur gears 38 can be connected to the massaging members 24, causing the massaging members to rotate when power is being supplied to the motor 30. One or more pole brackets 40 can be located about the pole 36 and connected to the body 12. This can be used to provide support for the pole 36. A seal (not shown) can be used to help protect the live part from getting wet.

The massaging member 24 can be made to be interchangeable with other members 24 of different textures or patterns for a wide variety of massaging sensations with many different massaging effects. They can be made to spin clockwise or counterclockwise. In a preferred embodiment of the present invention, the massaging members 24 adjacent to one another are made to rotate in opposite directions in order to counteract a sideways thrust force that could occur on a body part if the massaging members 24 are made to spin in the same direction. The massaging members 24 can be placed within the basin in any of a variety of ways, such as being slid into place, being snapped in, screwed in, or by using any other feasible method.

The footbath 10 can also include multiple locations for a powered pedicure. In a preferred embodiment, the pedicure mechanisms can be made to rotate in alternate directions and can be made to function in a non-water situation.

A control panel 26 is provided having buttons that are connected to an electronic control circuit of the type generally known. Various functions are controlled by the control panel 26. The control panel 26, in a preferred embodiment, is mounted as shown in FIG. 1 to be a body control panel having several buttons 28 to control the various features of the footbath 10. However, in an alternate embodiment, the control panel 26 could be removable to be used as a wireless remote control. The control panel 26 could also be adapted for toe control by having large buttons.

While a preferred embodiment of the invention has been herein disclosed and described, it is understood that various modifications can be made without departing from the scope of the invention.

What is claimed is:

1. A footbath comprising:
a housing;
a basin within said housing for holding water;
a heater within said footbath to heat the water in said basin;
at least one rotating massage member in said basin; and
a motor to drive said at least on rotating massage member,
wherein said at least one rotating massage member is selectively removable and replaceable.

2. A footbath according to claim 1, wherein
said rotating massage member is interchangeable with other massage members having any one of a variety of textures or patterns.

3. A footbath according to claim 1, wherein
said rotating massage member can spin clockwise or counter-clockwise.

4. A footbath according to claim 1, further comprising
a control panel to control the various features of said footbath.

5. A footbath according to claim 1, wherein
said rotating massage member is completely immersed in the water.

6. A footbath according to claim 1, wherein
said motor is located a safe distance from the top level of the water.

7. A footbath according to claim 1, further comprising
a seal to prevent water from contacting said motor.

8. A footbath according to claim 1, further comprising
a plurality of rotating massage members, wherein said rotating massage members spin in a direction opposite to each adjacent rotating massage member.

9. A footbath according to claim 4, wherein
said control panel is selectively removable from said housing.

10. A footbath according to claim 4, wherein
said control panel has buttons large enough to be operated by a user's toe.

11. A footbath according to claim 1, further comprising
a powered pedicure station.
